(19) United States
(12) Patent Application Publication
(10) Pub. No.: US 2015/0077788 A1
(43) Pub. Date: Mar. 19, 2015

(54) VALUE WEIGHTED PRINT AND RENDERING CONTROL METHODS, SYSTEMS AND PROCESSOR-READABLE MEDIA

(71) Applicant: Xerox Corporation, Norwalk, CT (US)

(72) Inventors: George A. Gibson, Fairport, NY (US); Michael R. Furst, Penfield, NY (US)

(73) Assignee: Xerox Corporation, Norwalk, CT (US)

(21) Appl. No.: 14/029,173

(22) Filed: Sep. 17, 2013

(51) Int. Cl. G06K 15/02

(52) U.S. Cl. CPC G06K 15/1809; G06K 15/1821
USPC 358/1.15

(57) ABSTRACT

Methods and systems for managing the rendering of documents in a rendering queue. In general, a set of criteria can be established for ranking a group of rendering jobs in a rendering queue. One or more jobs among the group of rendering jobs can be identified, which potentially constitutes a low value document. An alert can then be generated indicating that one or more of such jobs is potentially a low value document. Thereafter, a particular action can be instituted with respect to the identified job(s) if it is confirmed based on the alert that the identified job(s) is a low value document. Such a particular action can involve, for example, rendering (e.g., printing) the idenfitied job(s), modifying the idenfied job(s), preventing rendering of the identified job(s), etc.

### FIELD OF THE INVENTION

Embodiments are generally related to the management of printed output. Embodiments are also related to control systems. Embodiments further relate to print cost optimization.

### BACKGROUND

Several types of control systems have been described for the management of printed output. Such systems are driven based on the bedrock assumption that producing more print generates an expense to the individual, firm or world (i.e., the latter in the case of “green” objectives). These assumptions generally lead to the implementation and generation of various reminders, suggestions, default printing options or outright policy driven protocols and prohibitions. We are all familiar with tag or signature lines at the bottoms of emails reminding us to be thoughtful before printing. Such suggestions are less intrusive than outright prohibitions against email printing, but are also less effective at reducing print.

Some methods have been proposed which suggest the use of rules engines and modules, structured by and administrator to suggest or apply rendering techniques (B/W rather than color print, duplex rather than simplex, 5% magnification reduction) which have been determined, based on the job mix previously observed for that printer or mfd, taking into account consumables costs and ignoring B/W prints, to lead to the achievement of specific print cost goals. One example of such a prior art approach is disclosed in U.S. Patent Application Publication No. 201310033723 A1 entitled “Method and system for automatically recommending rules based on desired print criteria,” which is incorporated herein by reference in its entirety. These type of systems make the fundamental mistake of local optimization. That is, they assume that print is a cost only and that optimizing print cost is the sole objective. In fact print is embedded in a larger context such as, for example, the business of the firm.

Accordingly reducing print may indeed not optimize the firm's operating results. A multi page color brochure or customized sales presentation may indeed have a high marginal cost, but may also have high marginal value so discouraging such print is not in the best interest of the firm. Accordingly, where such systems impose mandatory print policies, they produce sub-optimal overall firm performance or where they produce suggestions only, they rely on the print job submitter to individually make the cost benefit trade-off without explicit knowledge of the costs.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved control method and system.

It is another aspect of the disclosed embodiments to provide for improved value weighted print and rendering control module and applications thereof.

It is a further aspect of the disclosed embodiments to provide for a controller and a module for improving the value of print.

The aforementioned aspects and other objectives and advantages can now be achieved as described herein. Methods and systems are disclosed for managing the rendering of documents in a rendering queue. In general, a set of criteria can be established for ranking a group of rendering jobs in a rendering queue. One or more jobs among the group of rendering jobs can be identified, which potentially constitutes a low value document. An alert can then be generated indicating that one or more of such jobs is potentially a low value document. Thereafter, a particular action can be instituted with respect to the identified job(s) if it is confirmed based on the alert that the identified job(s) is a low value document. Such a particular action can involve, for example, rendering (e.g., printing) the identified job(s), modifying the identified job(s), preventing rendering of the identified job(s), etc.

In another embodiment, the group of rendering jobs in the rendering queue can be analyzed. Then, an absolute value or a relative value of each rendering job among the group of rendering jobs in the rendering queue can be assessed. A determination can then be made as to which rendering jobs among the rendering jobs are to be rendered based on the absolute value or the relative value of each rendering job assessed.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example chart indicative of a value based priority set that can be used at a department, work group or firm level, in accordance with a preferred embodiment;

FIG. 2 illustrates a high-level flow chart of operations depicting logical operational steps of a method for value weight print and rendering control, which can be implemented in accordance with a preferred embodiment;

FIGS. 3A and 3B illustrate a schematic diagram of an example 10% asymmetrically reduced email with a banner added to obviate the need for a cover sheet, in accordance with an alternative embodiment;

FIG. 4 illustrates a high-level flow chart of operations depicting logical operational steps of a method for controlling and improving the value of print, which can be implemented in accordance with a preferred embodiment;

FIG. 5 illustrates a schematic view of a computer system, which can be implemented in accordance with one or more of the disclosed embodiments;

FIG. 6 illustrates a schematic view of a software system including an anomaly detection module, an operating system, and a user interface, in accordance with one or more embodiments; and

FIG. 7 illustrates a schematic diagram of a print management system 200 associated with a network, which can be implemented in accordance with or more embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The disclosed embodiments are described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The disclosed embodiments describe in part a print cost optimization approach that utilizes the assessment of the value of print rather than of its cost to provide policies or suggestions to modify print behavior. In this scheme, documents (e.g., emails, forms that are part of managed business processes, spreadsheets, PowerPoint™ presentations, etc.) can be assessed for their relative value to accomplishing the business objectives of the firm. Such an assessment may rely not only on the type of document format, but also its content, origin, and its relationship (or lack thereof) to an established and actively managed business process. This priority list can be utilized to serve recommendations to print job submitters or which may serve as the basis of categorical policies recommended or applied as defaults to jobs in the print queue.

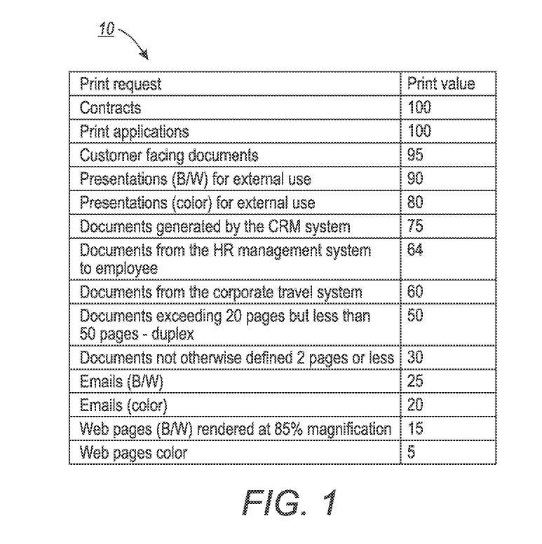

Such an approach can be implemented whether in the print queue as is suggested in the rendering example discussed herein with respect to FIG. 1 or may operate on individual's computer or work station. In the case of operating on individuals' hardware, the judgments of document value can be selected not merely to optimize firm performance, but also to meet individual performance improvement goals.

The disclosed approach may operate passively acting only on those files that the user tries to print or, in some embodiments, might actively search new data sources (e.g., new emails) and identify documents which, under the value based rules described, are of particularly high value to print. Having identified such files, the system can either notify the user of the opportunity or directly initiate printing.

It may be helpful to discuss the criteria that can be considered when determining the value of a given print. First, it will be appreciated that such value discussions can be either absolute (e.g., we must always have hand-signed physical copies of legal agreements of the following sorts), relative (e.g., it is faster for me to read documents of greater than 10 pages from hard copy than from a screen) or even contextual (e.g., before I travel I will need to print today's emails because I will have time but no email access while in the air).

Absolute print value can derive from legal or regulatory requirements or from formal valuation models. An example is a computer resident form in an electronic medical record system explaining a proposed procedure to a patient with a facility for the patient to acknowledge receipt of the information and document his or her informed consent. Such a document must contain information specific to the patient (hence idiosyncratic) and to current regulatory and health delivery facility specific requirements and policies. Since these change frequently, pre-printed forms will suffer obsolescence and may require manual data entry to render their contents electronically parsable.

Accordingly, it may be very valuable to print such a document. Other examples of types of documents whose print value will be obvious to those skilled in the art, but include certain types of certificates of compliance, inspection documents, legal documents including submissions to some government agencies (e.g., see http://travel.state.gov/visa/immigrants/info/info_{—}3195.html) and contracts. Further, documents which will be physically viewed by multiple parties (e.g., proofs) may be of high value especially vis-à-vis the alternative of each person receiving their own copy of a document and making multiple prints. Additional examples of documents which may be of high value as print are those required by corporate policy as part of a formally managed business process and certain sales or marketing documents or collaterals which are intended for delivery to customers or prospects. A value based print prioritization schema might examine a sales executive's day's schedule by interrogating their CRM system and prompt the executive to complete and print sales and marketing collaterals customized or personalized to the clients that she or he will visit that day.

An example of a value based priority set that might be employed at a firm level is shown in FIG. 1, which illustrates an example chart 10 indicative of a value based priority set that can be employed at a firm level, in accordance with a preferred embodiment. The values expressed in chart 10 are arbitrary and meant as examples only and both the quantitative and rank ordering will be expected to be firm and, in the case of the personal implementation suggested previously, perhaps even person specific. Chart 10 shown in FIG. 1 includes a variety of jobs or job parameters such as print request, contracts, print applications, customer facing documents, etc., as shown in the left hand column of chart 10. The respective print values are shown in the right hand column of chart 10.

Such a ranking can be accomplished by several means. A formal model can be encoded in a rules engine which can calculate value-based ranking taking as inputs explicit benefit and cost models, including both the capital and variable cost of print. Such a system will allow priorities to be changed as costs and benefits change (viz. new supplies contract or printing device, new information about the effectiveness of a given presentation or collateral type, new regulatory or policy decisions, . . . ). Alternatively, an administrator may make the value assessment and encode only the results of such analysis in the print prioritization matrix.

A personal version of the same system scheme may contain a rules engine which takes into account the characteristics of the individual and the objectives that they set for themselves. Such a system would solicit information about the user and his or her goals and post a priority matrix based on the analysis of those data. A person might, for instance always process mail faster when reading from hard copy than from a screen or other electronic presentment device. In such a case a high priority would be assigned to printing email and, indeed, such a system might simply print all emails that the person receives without the need for him or her to manually initiate such an action. Alternatively, it might be desirable that all emails less than one page in length be read and responded to from the screen; accordingly, such print jobs would be assigned a low value priority and receive the structured action (e.g., reminder, application of rendering defaults, prohibition, . . . ). Further, an individual might always want to read long documents away from the office and electronic infrastructure connectivity so again, a high print value would be assigned to such documents.

A user might not experience significant disutility in reading documents at 90% of their original magnification; accordingly, such magnification might be applied by default to materials printed without altering their relative value priority. In another scheme, default rendering options (e.g., reduced print magnification, B/W printing, duplex printing, inexpensive (perhaps thin) paper use) might be applied to all printing jobs at a specified value rank or absolute value. It can be seen that a variety of such schema can be developed and applied at either a corporate or individual level.

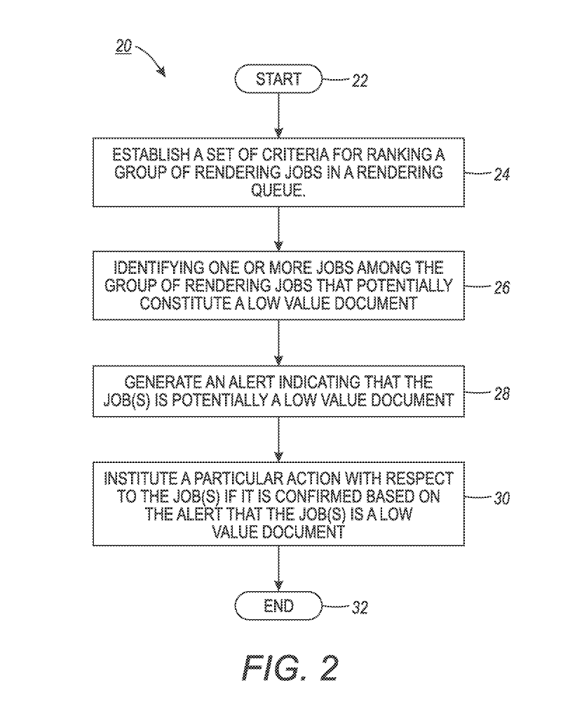

FIG. 2 illustrates a high-level flow chart of operations depicting logical operational steps of a method 20 for value weight print and rendering control, which can be implemented in accordance with a preferred embodiment. The method 20 shown in FIG. 2 can be implemented to manage the rendering of documents in a rendering queue. As shown at block 22, the process can be initiated. Thereafter, as depicted at block 24, a set of criteria can be established for ranking a group of rendering jobs in a rendering queue. Next, as illustrated at block 26, one or more jobs among the group of rendering jobs can be identified, which potentially constitutes a low value document. Then, as described at block 28, an alert can then be generated indicating that one or more of such jobs is potentially a low value document. Thereafter, as depicted at block 30, a particular action can be instituted with respect to the identified job(s) if it is confirmed based on the alert that the identified job(s) is a low value document. Such a particular action can involve, for example, rendering (e.g., printing) the identified job(s), modifying the identified job(s), preventing rendering of the identified job(s), etc. The process can then terminate, as shown at block 32.

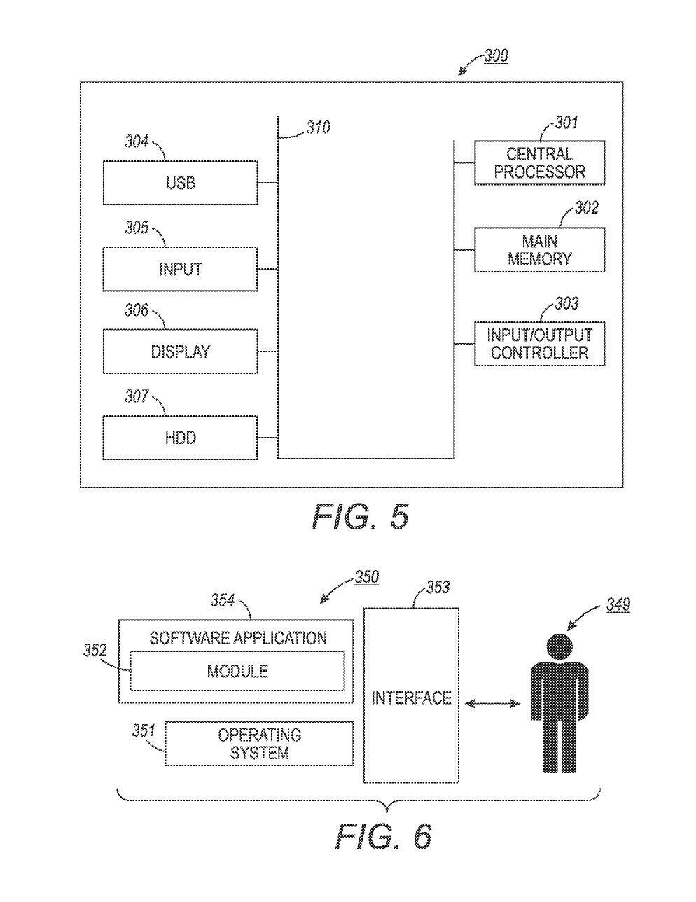

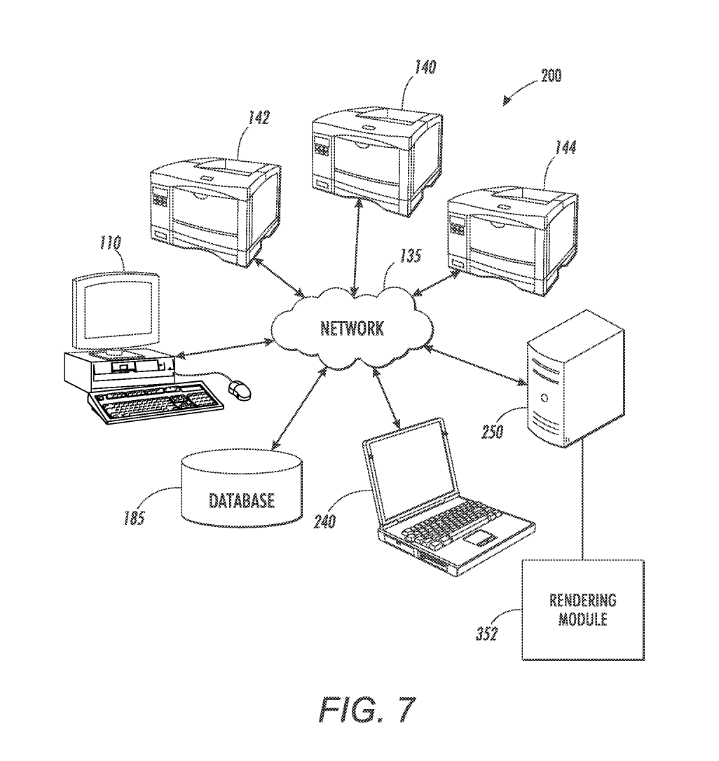

Accordingly, it can be appreciated that a print management method and system can be implemented, which includes the use of a print management module (e.g., see module 352 shown in FIGS. 6 and 7) that is configured to apply a set of rendering restrictions or recommendations based on an assessment of the value of the printed material. Such a value can be established either qualitatively or quantitatively and a facility provided for changing the values based assessment as costs and value change over time is encoded as a value matrix which is accessed by the rendering module 352. Optionally, a facility may be provided that executes print automatically in a manner responsive to the value matrix and to the inputs derived from work load generation systems such as centrally managed business processes and CRM systems. In this way, the value impact of print can be optimized.

Note that in another embodiment, a system of print value increase can be implemented where content is added to a document before printing which improves its value in the context of the firm. We recognize that absent absolute prohibition some amount of relatively low value (to the firm) documents will be produced. This will happen, for instance, because such documents are valuable in the context of an individual's work practice. The desire of some workers to print all emails is a representative example. Certain individuals find it faster to read emails from paper rather than from a screen and, accordingly, continue to print even short emails. In the context of the firm, only a very large value of the person's time would likely justify such a process. On the other hand, a strict prohibition against such practices might be difficult to administer and enforce and be an unwelcome intrusion into the detailed work process of individuals.

An alternative is to identify low value printing submissions before they are printed, change the rendering in a way which makes space for additional content, and insert material judged to be of relatively high (or at least higher) content. This increases the value the firm obtains from the printing that is carried out on its behalf.

In this scheme, a basis must be established for analyzing documents in a print queue and assessing their absolute or relative value. Such system is discussed earlier herein. In that scheme, an administrator, with or without the aid for formal valuation models, establishes a set of criteria that ranks print job types by value. Decisions can then be made regarding the rendering of those documents judged to be of low value, viz their print may be prohibited, a message might be sent to the print submitter alerting him or her to the fact that he or she has asked to print a low value document and requesting confirmation of that request or the document rendering may be changed, eliminating color or reducing magnification for instance. While these putatively reduce the cost of print, the agent bearing that cost is not the same as the one requesting the print so some misalignment of actions is to be anticipated.

In such an embodiment, low value documents can be identified via a rules engine in the print path using input from an administrator as is described in the preceding disclosures. Further, another set of information can be similarly identified as being of higher value. The rendering of the low value documents is then modified such that high (or higher) value content can be fit on the same printed page. The jobs can then be merged and the composite page printed.

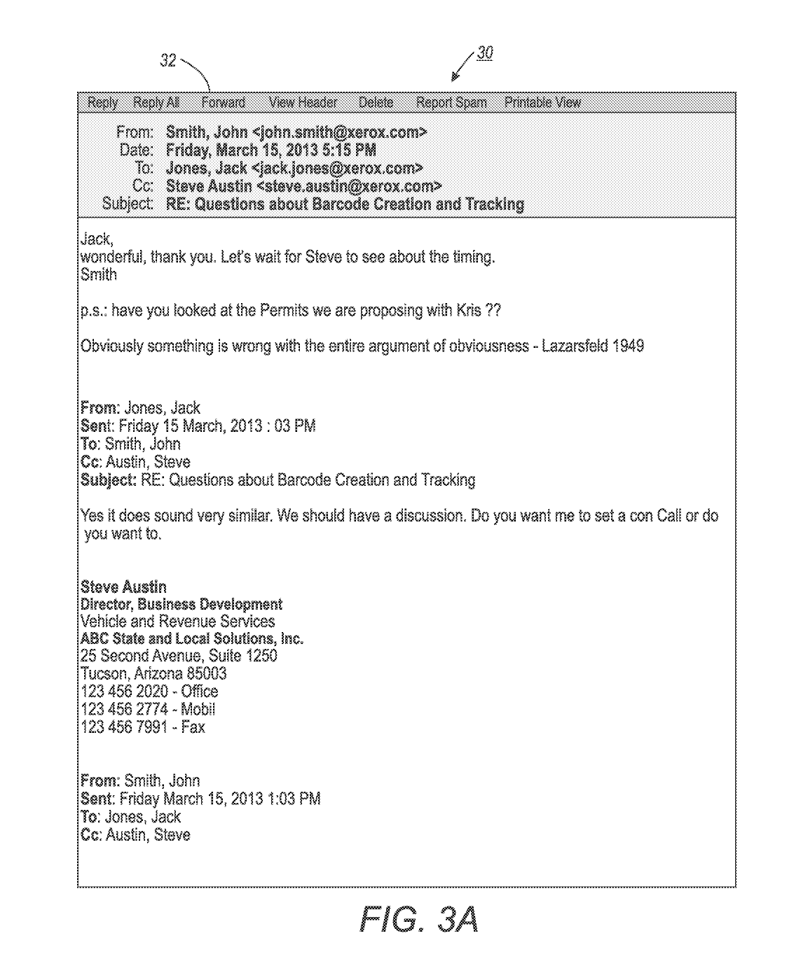

A simple example of such an implementation involves the elimination of cover sheets from single page emails (e.g., see the example shown in FIG. 3 and discussed in greater detail below). In this case, half of the paper expense, which itself can be the most significant component cost of a print, is eliminated. The cover sheet information is printed as a masthead on the same page as the originally intended document by, for instance, asymmetrically shrinking the originally intended image by, for example, 10% vertically. In this case, the new document has value added by cost avoidance. There are a wide variety of other value-adding contents that can be employed in this manner. Firms have the periodic requirement to communicate with their employees. These communications, if they are of sufficiently valuable, can be printed as described.

Document value can also be increased by printing machine readable contents which help to ease the document from the realm of print back into the electronic realm. A code might, for instance, be printed on the document which directs a network enabled scanner (which might be part of a MFD) to send the document to a given email address or file location in a particular file format. This combination adds value by allowing effort reduction in a subsequent document action. Use cases here include the off-line editorial mark-up of document during creation or revision and data capture of data from added manually to an electronically generated form. Many others will be obvious to those skilled in the art.

FIG. 3B thus illustrates a schematic diagram of a 10% asymmetrically reduced email 34 with a banner added to obviate the need for a cover sheet, in accordance with an alternative embodiment. Email 34 is shown in FIG. 3B with respect to the original email 32 shown in FIG. 3A. The banner of email 34 is indicated with simply the name “GIBSON”. Note that the inclusion of the addition of machine readable codes for these purposes to affect the priority of print in an environment where print is value gated is novel. Additional value added content can be similarly included under control of a value prioritization matrix.

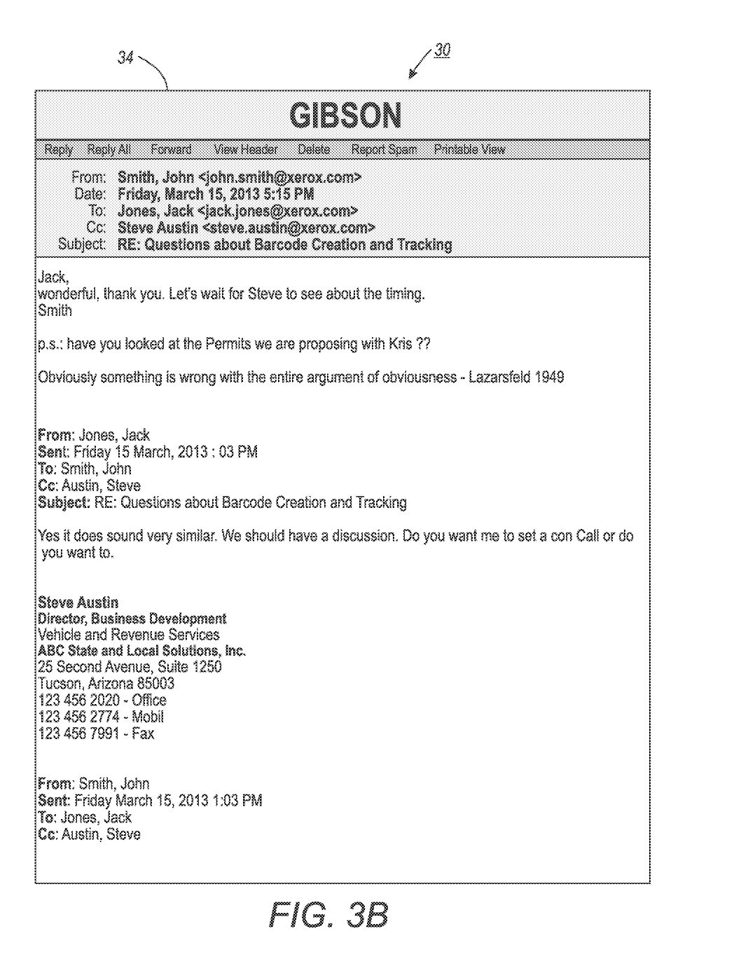

FIG. 4 illustrates a high-level flow chart of operations depicting logical operational steps of a method 40 for controlling and improving the value of print, which can be implemented in accordance with a preferred embodiment. Note that the method 40 shown in FIG. 4 can be implemented alone or in association with the method 20 depicted in FIG. 2. Thus, as depicted at block 42, the process can be initiated. Thereafter, as indicated at block 44, the group of rendering jobs in the rendering queue can be analyzed. Then, as shown at block 46, an absolute value or a relative value of each rendering job among the group of rendering jobs in the rendering queue can be assessed. Thereafter, as depicted at block 48, a determination can then be made as to which rendering jobs among the rendering jobs are to be rendered based on the absolute value or the relative value of each rendering job assessed. The process can then terminate as shown at block 50.

Thus, in an alternative embodiment, a print management method and system can be implemented which includes, for example, a print management module such as module 352 shown in FIGS. 6-7, which applies an assessment of the value of the material to be printed. This assessment can be conducted under the control of a rules engine in which an administrator creates, with or without the assistance of formal valuation models, a value matrix describing various potential print submissions and their relative or absolute value to the firm. The administrator can further create in the rules engine, a hierarchy of value adding content. In those cases where print submitters request printing of a low value document, the rendering is modified in a rendering module prior to print to change the rendering of the low value document in such a manner that value adding content can be printed on the same page, increasing the value of the print. This may or may not be conducted with notification of the print submitter. It should be recognized that the option to add selected value adding components such as the machine readable codes described by reference above. In this way the value impact of print can be increased.

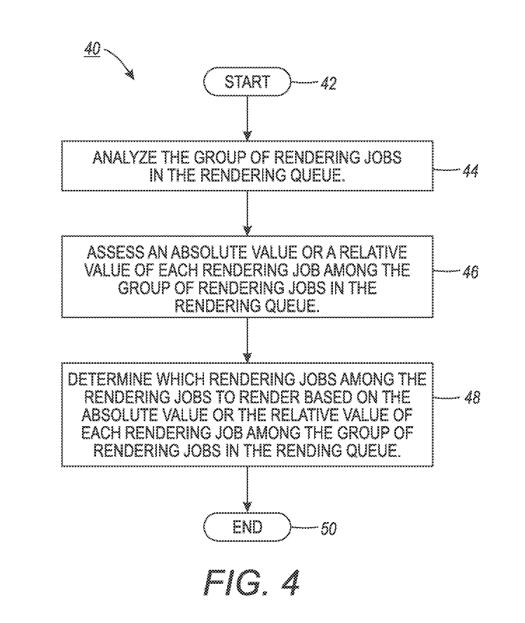

FIGS. 5-6 are provided as exemplary diagrams of data-processing environments in which embodiments of the present invention may be implemented. It should be appreciated that FIGS. 5-6 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 5, the disclosed embodiments may be implemented in the context of a data-processing system 300 that can include, for example, a central processor 301 (or other processors), a main memory 302, a controller 303, and in some embodiments, a USB (Universal Serial Bus) 304 or other appropriate peripheral connection. System 300 can also include an input device 305 (e.g., a keyboard, pointing device such as a mouse, etc.), a display 306, and a HDD (Hard Disk Drive) 307 (e.g., mass storage). As illustrated, the various components of data-processing system 300 can communicate electronically through a system bus 310 or similar architecture. The system bus 310 may be, for example, a subsystem that transfers data between, for example, computer components within data-processing system 300 or to and from other data-processing devices, components, computers, etc.

FIG. 6 illustrates a computer software system 350, which may be employed for directing the operation of the data-processing system 300 depicted in FIG. 5. Software application 354, stored in memory 302 and/or on HDD 307 generally can include and/or can be associated with a kernel or operating system 351 and a shell or interface 353. One or more application programs, such as module(s) 352, may be “loaded” (i.e., transferred from mass storage or HOD 307 into the main memory 302) for execution by the data-processing system 300. In the example shown in FIG. 6, module 352 can be implemented as, for example, a software module that performs the logical instructions or operations shown in FIGS. 2 and 4, and so forth.

The data-processing system 300 can receive user commands and data through user interface 353 accessible by a user 349. These inputs may then be acted upon by the data-processing system 300 in accordance with instructions from operating system 351 and/or software application 354 and any software module(s) 352 thereof.

The discussion herein is thus intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules (e.g., module 352) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific; task such as word processing, accounting, inventory management, etc.

The interface 353 (e.g., a graphical user interface) can serve to display results, whereupon a user may supply additional inputs or terminate a particular session. In some embodiments, operating system 151 and interface 353 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 351 and interface 353,

FIGS. 5-6 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms, including Macintosh, Unix, Linux, and the like.

FIG. 7 illustrates a schematic diagram of a print management system 200 associated with a network 135, which can be implemented in accordance with one or more embodiments. The print management system 200 generally includes a network 135 and one or more rendering devices 140, 142, and 144, which can communicate with the network 135. System 200 additionally can include a data-processing system 110, a rendering server 250, and a database 185. Data-processing system 110 depicted in FIG. 2 can also be, for example, a server.

Other devices such as, for example, desktops, network devices, palmtops, mobile phones, tablet computers, etc., may also be included with the network infrastructure 135 as service providers, depending upon design implementations. For example, a laptop computer 240 or other portable device (e.g., a Smartphone) may communicate with network 135. The data-processing system 110 in some cases is analogous to the data-processing system 300 shown in FIG. 5. The rendering devices 140, 142, and 144 can be located remotely with respect to each other, or alternatively, they may be located locally with respect to each other. It is assumed that network 135 has wireless communication capability and that the connection(s) between the various components such as 110, 142, 140, 144, 250, etc., with network 135 may be wireless in nature.

Server 250 may further include or communicate with the rendering module 352, which in some cases functions as a print management module and can implement the various instructions and logical operations discussed herein such as, for example, the instructions shown in FIGS. 2 and 4.

The rendering device 140 in one example, may be an office machine that incorporates the functionality of multiple devices in one so as to provide centralized document management, document distribution, and production in a large-office setting and the like. A typical rendering device can act as a combination of a printer, scanner, photocopier, fax, and e-mail. While three rendering devices 140, 142, and 144 are shown by way of example, it is to be appreciated that any number of rendering devices can be linked to the network 135 such as two, four, six or more rendering devices.

In general, the rendering devices 140, 142, and 144 can be employed to perform a rendering output function (e.g., printing, scanning, copying, faxing, etc.) within a networked environment. Each rendering device 140, 142, and 144 in communication with the network 135 may collect its own data and store a persistent history associated with the data locally on the database 185 accessible by the rendering devices 140, 142, and 144. Note that rendering devices 140, 142, and 144 are generally analogous to one another.

Based on the foregoing, it can be appreciated that a number of varying embodiments are disclosed. For example, in one embodiment, a method can be implemented for managing rendering of documents in a rendering queue. Such a method can include the steps or logical operations of, for example, establishing a set of criteria for ranking a group of rendering jobs in a rendering queue; identifying at least one job among the group of rendering jobs that potentially comprises a low value document; generating an alert indicating that the at least one job is potentially a low value document; and instituting a particular action with respect to one or more of the jobs if it is confirmed based on the alert that one or more of the jobs comprises a low value document.

In another embodiment, the particular action may constitute one or more jobs. In yet another embodiment, the particular action may involve modifying one or more jobs. In still another embodiment, the particular action may include preventing rendering of one or more jobs.

In still another embodiment, steps or logical operations can be provided for analyzing the group of rendering jobs in the rendering queue; assessing an absolute value or a relative value of each rendering job among the group of rendering jobs in the rendering queue; and determining which rendering jobs among the rendering jobs to render based on the absolute value or the relative value of each rendering job among the group of rendering jobs in the rendering queue.

In another embodiment, a step or logical operation can be implemented for providing a rules engine for identifying one or more of the jobs among the group of rendering jobs that potentially comprises the low value document. In another embodiment, a step or logical operation can be provided for locating the rules engine in a rendering path with respect to the rendering queue.

In another embodiment, a system can be implemented for managing rendering of documents in a rendering queue. Such a system can include, for example, a processor and a computer-usable medium embodying computer program code, the computer-usable medium capable of communicating with the processor. The computer program code can include instructions executable by the processor and configured, for example, for establishing a set of criteria for ranking a group of rendering jobs in a rendering queue; identifying at least one job among the group of rendering jobs that potentially comprises a low value document; generating an alert indicating that one or more of the jobs is potentially a low value document; and instituting a particular action with respect to one or more of the jobs if it is confirmed based on the alert that one or more of the jobs comprises a low value document.

In another system embodiment, such instructions can be further configured for analyzing the group of rendering jobs in the rendering queue; assessing an absolute value or a relative value of each rendering job among the group of rendering jobs in the rendering queue; and determining which rendering jobs among the rendering jobs to render based on the absolute value or the relative value of each rendering job among the group of rendering jobs in the rendering queue.

In another system embodiment, a rules engine can identify one or more of the jobs among the group of rendering jobs that potentially comprises the low value document. In yet another system embodiment, he rules engine can be located in a rendering path with respect to the rendering queue.

In still another embodiment, a processor-readable medium storing code representing instructions to cause a process for managing rendering of documents in a rendering queue can be implemented. Such code can include code, for example to: establish a set of criteria for ranking a group of rendering jobs in a rendering queue; identify at least one job among the group of rendering jobs that potentially comprises a low value document; generate an alert indicating that one or more of the jobs is potentially a low value document; and institute a particular action with respect to one or more of the jobs if it is confirmed based on the alert that one or more of the jobs comprises a low value document.

In another embodiment, such code can include code to analyze the group of rendering jobs in the rendering queue; assess an absolute value or a relative value of each rendering job among the group of rendering jobs in the rendering queue; and determine which rendering jobs among the rendering jobs to render based on the absolute value or the relative value of each rendering job among the group of rendering jobs in the rendering queue. In yet another embodiment, such code can include code to operate a rules engine for identifying one or more of the jobs among the group of rendering jobs that potentially comprises the low value document.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, a server can include one or more computers operating as a web server, database server, or other type of computer server in a manner to fulfill described roles, responsibilities, or functions. Within the context of this document, the disclosed devices, assemblies, and so forth are also deemed to include computing devices having a processor and a non-transitory memory storing instructions executable by the processor that cause the device to control, manage, or otherwise manipulate the features of the assemblies.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those sidled in the art which are also intended to be encompassed by the following claims.

1. A method for managing printing of documents in a printing queue, said method comprising:
establishing a set of criteria for ranking a plurality of print jobs in a print queue;
identifying at least one print job among said plurality of print jobs that potentially comprises a low value document;
generating an alert indicating that said at least one print job is potentially a low value document; and
instituting a particular action with respect to said at least one print job if it is confirmed based on said alert that said at least one print job comprises a low value document.

2. The method of claim 1 wherein said particular action comprises printing said at least one print job.

3. The method of claim 1 wherein said particular action comprises modifying the content of the low value document.

4. The method of claim 1 wherein said particular action comprises preventing printing of said at least one job.

5. The method of claim 1 further comprising:
analyzing said plurality of print jobs in said print queue;
assessing an absolute value or a relative value based on the type of document to be rendered of each print job among said plurality of rendering jobs in said rendering queue; and
determining which print jobs among said print jobs to render based on said absolute value or said relative value of each print job among said plurality of rendering jobs in said rendering queue.

6. The method of claim 1 further comprising providing a rules engine for identifying said at least one print job among said plurality of print jobs that potentially comprises said low value document.

7. The method of claim 6 further comprising locating said rules engine in a rendering path with respect to said rendering queue.

8. A system for managing printing of documents in a printing queue, said system comprising:
a processor; and
a computer-usable medium embodying computer program code, said computer usable medium capable of communicating with the processor, said computer program code comprising instructions executable by said processor and configured for:
establishing a set of criteria for ranking a plurality of print jobs in a print queue;
identifying at least one job among said plurality of print jobs that potentially comprises a low value document;
generating an alert indicating that said at least one job is potentially a low value document; and
instituting a particular action with respect to said at least one print job if it is confirmed based on said alert that said at least one print job comprises a low value document.

9. The system of claim 8 wherein said particular action comprises printing said at least one print job.

10. The system of claim 8 wherein said particular action comprises modifying the content the said low value document.

11. The system of claim 8 wherein said particular action comprises preventing printing of said at least one print job.

12. The system of claim 8 wherein said instructions are further configured for:
analyzing said plurality of print jobs in said print queue;
assessing an absolute value or a relative value of each print job among said plurality of print jobs in said print queue; and
determining which print jobs among said print jobs to render based on said absolute value or said relative value of each print job among said plurality of print jobs in said print queue.

13. The system of claim 8 further comprising a rules engine for identifying said at least one print job among said plurality of print jobs that potentially comprises said low value document.

14. The system of claim 13 wherein said rules engine is locating in a rendering path with respect to said rendering queue.

15. A non-transitory processor-readable medium storing code representing instructions to cause a process for managing rendering of documents in a rendering queue, said code comprising code to:
establish a set of criteria for ranking a plurality of print jobs in a print queue;
identify at least one print job among said plurality of print jobs that potentially comprises a low value document;
generate an alert indicating that said at least one print job is potentially a low value document; and
institute a particular action with respect to said at least one print job if it is confirmed based on said alert that said at least one print job comprises a low value document.

16. The non-transitory processor-readable medium of claim 15 wherein said particular action comprises printing said at least one print job.

17. The processor-readable medium of claim 15 wherein said particular action comprises modifying the content of said low value document.

18. The processor-readable medium of claim 15 wherein said particular action comprises preventing printing of said at least one print job.

19. The processor-readable medium of claim 15 wherein said code further comprises code to:
analyze said plurality of print jobs in said print queue;
assess an absolute value or a relative value of each print job among said plurality of print jobs in said print queue; and
determine which print jobs among said print jobs to print based on said absolute value or said relative value of each print job among said plurality of print jobs in said print queue.

20. The processor-readable medium of claim 15 further comprising code for operating a rules engine for identifying said at least one print job among said plurality of print jobs that potentially comprises said low value document.
